(19) United States
(12) Patent Application Publication
(10) Pub. No.: US 2022/0065405 A1
(43) Pub. Date: Mar. 3, 2022

(54) METHODS AND APPARATUS FOR CONCURRENT DIGITAL PRESSURE ANALYSIS

(71) Applicant: Hecate Software, Inc., Richland, WA (US)

(72) Inventors: Michael Garley, Covington, LA (US); Brian LaMarche, Richland, WA (US)

(21) Appl. No.: 17/459,895

(22) Filed: Aug. 27, 2021

Related U.S. Application Data
(60) Provisional application No. 63/071,235, filed on Aug. 27, 2020.

(51) Int. Cl. F17D 5/02; G01L 19/00; F17D 5/00

(52) U.S. Cl. CPC F17D 5/02; G06Q 50/08; F17D 5/005; G01L 19/0092

(57) ABSTRACT

Provided is a tangible, non-transitory, machine-readable medium storing instructions that when executed by one or more processors effectuate operations including: obtaining, with one or more processors, a plurality of user-supplied optimum operating values corresponding to a plurality of operating parameters in an oil and gas facility, obtaining, with one or more processors, a plurality of measured operating parameters.

### CROSS-REFERENCE TO RELATED APPLICATIONS

This patent claims the benefit of U.S. Provisional Patent Application 63/071235, filed 27 Aug. 2020, titled METHODS AND APPARATUS FOR CONCURRENT DIGITAL PRESSURE ANALYSIS. The entire content of this application is hereby incorporated by reference for all purposes.

### BACKGROUND

### 1. Field

The present disclosure relates generally to pressure analysis and, more particularly, to computer-implemented concurrent and sequential pressure analysis in the oil & gas industry.

### 2. Description of the Related Art

In the oil and gas industry, pressurized components are ubiquitous. It is necessary to periodically monitor pressure in the pipelines and other components.

Over the years, there have been a number of methods utilized to perform pressure control and achieve digital analysis. Of particular interest here is the ability to monitor and control pressure concurrently at multiple different locations in a time efficient manner.

### SUMMARY

The following is a non-exhaustive listing of some aspects of the present techniques. These and other aspects are described in the following disclosure.

Some aspects include tangible, non-transitory, machine-readable medium storing instructions that when executed by one or more processors effectuate operations including obtaining, with one or more processors, a plurality of user-supplied optimum operating values corresponding to a plurality of operating parameters in an oil and gas facility; obtaining, with one or more processors, a plurality of measured operating parameters, wherein: each of the measured operating parameters of the plurality of measured operating parameters is obtained concurrently from a detection package, the detection package comprising: at least one of a plurality of input sensors, wherein: each of the plurality of input sensors is operatively coupled to at least one of the operating parameters in an oil and gas facility; each of the plurality of input sensors has a radio frequency identification; at least some of the plurality of input sensors are pressure sensors; and at least some of the plurality of input sensors are temperature sensors; generating, with one or more processors, a pressure testing assessment using the plurality of measured operating parameters, the plurality of user-supplied optimum operating values, and a criteria associated with the pressure testing; and storing, with one or more processors, the pressure testing assessment for subsequent output and monitoring of the oil and gas facility.

Some aspects include a system, including one or more processors, and memory storing instructions that, when executed by the processors, cause the processors to effectuate operations of the above-mentioned process.

It should be appreciated that the present invention can be implemented in numerous ways, including as a process, an apparatus, a system, a device, a method, or a computer-readable medium. Several inventive embodiments of the present invention are described below.

### BRIEF DESCRIPTION OF THE DRAWINGS

The above-mentioned aspects and other aspects of the present techniques will be better understood when the present application is read in view of the following figure in which like numbers indicate similar or identical elements:

FIG. 1 is a block logical and physical architecture diagram showing an embodiment of a system for concurrent and sequential digital pressure analysis in accordance with some of the present techniques;

FIG. 2 is a flowchart showing an example of a process by which concurrent and sequential digital pressure analysis may be performed in accordance with some of the present techniques;

FIG. 3 illustrates an example of a computing device by which the present techniques may be implemented.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION OF CERTAIN EMBODIMENTS

To mitigate the problems described herein, the inventors had to both invent solutions and, in some cases just as importantly, recognize problems overlooked (or not yet foreseen) by others in the field of fluid mechanics. Indeed, the inventors wish to emphasize the difficulty of concurrent and sequential digital pressure analysis of pressure control equipment within the oil & gas industry. Further, because multiple problems are addressed, it should be understood that some embodiments are problem-specific, and not all embodiments address every problem with traditional systems described herein or provide every benefit described herein. That said, improvements that solve various permutations of these problems are described below.

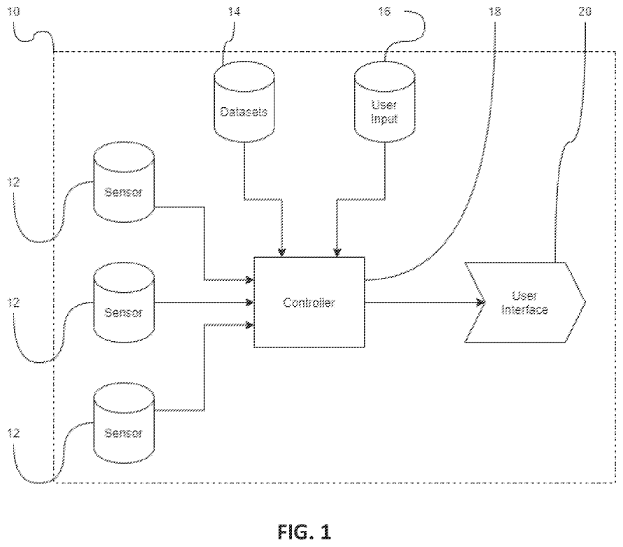

In some embodiments, a system for concurrent and sequential digital pressure analysis is described for an oil and gas facility or structure (e.g. a subsea oil and gas production, drilling or storage facility, etc.). FIG. 1 is a block logical and physical architecture diagram showing an embodiment of system for concurrent and sequential digital pressure analysis 10 that may include a series of sensors 12, datasets 14, user-input values 16, a controller 18, and a user interface 20.

In some embodiments, a system for concurrent and sequential digital pressure analysis may include various number of sensors (e.g. 1, 2, 3, 5, 10, 50, or 100 sensors) to measure the operating parameters.

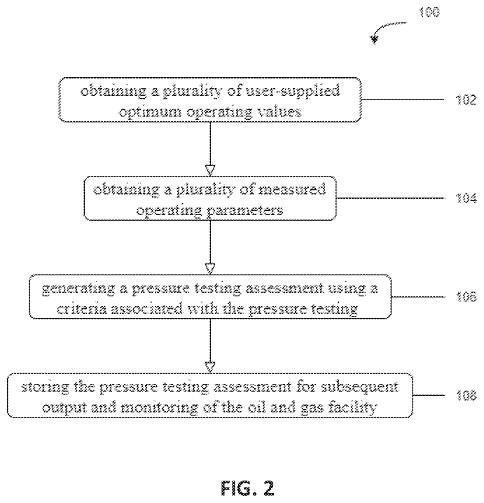

In some embodiments, the system for concurrent and sequential digital pressure analysis 10 may be configured to execute the process 100 described below with reference to FIG. 2. In some embodiments, different subsets of this process 100 may be executed by the illustrated components of the system for concurrent and sequential digital pressure analysis 10, so those features are described herein concurrently. It should be emphasized, though, that embodiments of the process 100 are not limited to implementations with the architecture of FIG. 1, and that the architecture of FIG. 1 may execute processes different from that described with reference to FIG. 2, none of which is to suggest that any other description herein is limiting.

In some embodiments, a pressure testing system 10 may collect data from a high-speed multi-channel digitizer which samples the electronic waveform produced by a device that measures pressure or temperature. In addition to performing signal acquisition, sampling, and processing, the pressure testing system 10 may send data to other software applications for analysis or storage. The pressure testing system 10 may generate its own data files in a computer binary format. This file may contain the raw waveform collected during the tests (e.g. 1000 samples/second) or a sub-sampling (e.g. averaging of 1000 samples) of the waveform.

In some embodiments, a pressure testing system 10 may apply signal processing techniques, including resampling, weighting, filtering, and spectrum processing by processors such as field-programmable gate array (“FPGAs”), digital signal processor (“DSP”), microprocessors, micro-controllers, or a combination thereof.

In some embodiments, a pressure testing system 10 may include sensor overload identification. The system may identify when their system is overloading, and determine if the overload is from the sensor, enabling the user to address the overloading adequately.

In some embodiments, a pressure testing system 10 may include radio frequency identification (“RFID”) and an inclinometer or accelerometer on sensors so each sensor may indicate what machine/bearing it is attached to and what direction such that the system may automatically store the data without the user input.

In some embodiments, a pressure testing system 10 may include a cloud-based policy automation engine for IoT, with creation, deployment, and management of IoT devices. Polices, which may include access policies, network usage policies, storage usage policies, bandwidth usage policies, device connection policies, security policies, rule-based policies, role-based polices, and others, may be required to govern the use of IoT devices.

In some embodiments, a pressure testing system 10 may include a plurality of sensors for measuring attributes associated with a pump such as temperature of bearings or pump housing vibration of a driveshaft associated with the pump, vibration of input or output lines, pressure, flow rate, fluid particulate measures, vibrations of the pump housing, and the like. These sensors may be connected either directly to a monitoring device or through an intermediary device using a mix of wired and wireless connection techniques.

In some embodiments, a monitoring device may have access to detection values corresponding to the sensors where the detection values correspond directly to the sensor output of a processed version of the data output such as a digitized or sampled version of the sensor output. In some embodiments, the sensors may include multiple temperature sensors positioned around the pump to identify hot spots among the bearings or across the pump housing which might indicated potential bearing failure and a leakage. For some pumps, when the fluid being pumped is corrosive or contains large amounts of particulates, there may be damage to the interior components of the pump in contact with the fluid due to cumulative exposure to the fluid. This may be reflected in unanticipated variations in output pressure. Additionally or alternatively, if a gear in a gear pump begins to corrode and no longer forces all the trapped fluid out this may result in increased pump speed, fluid cavitation, and/or unexpected vibrations in the output pipe.

In some embodiments, a pressure testing system 10 may include a plurality of sensors for measuring attributes associated with a compressor such as temperature of bearings or compressor housing, vibration of a driveshaft, transmission, gear box and the like associated with the compressor, vessel pressure, flow rate, and the like. These sensors may be connected either directly to a monitoring device or through an intermediary device using a mix of wired and wireless connection techniques.

In some embodiments, a monitoring device may have access to detection values corresponding to the sensors where the detection values correspond directly to the sensor output of a processed version of the data output such as a digitized or sampled version of the sensor output. The monitoring device may process the detection values to identify unexpected vibrations in the shaft, unexpected temperature values or temperature changes in the bearings or in the housing in proximity to the bearings that might cause a leakage. In some embodiments, the sensors may include multiple temperature sensors positioned around the compressor to identify hot spots among the bearings or across the compressor housing, which might indicate potential bearing failure. In some embodiments, sensors may monitor the pressure in a vessel storing the compressed gas. Changes in the pressure or rate of pressure change may be indicative of problems with the compressor.

In some embodiments, information about the health or other status or state information of or regarding a component or piece of equipment in an oil and gas facility may be obtained by monitoring the condition of various components throughout a process. Monitoring may include monitoring the amplitude of a sensor signal measuring attributes such as pressure, temperature, humidity, acceleration, displacement, and the like.

In some embodiments, selection of the sensors for monitoring a specific component or piece of equipment may depend on a variety of considerations such as accessibility for installing new sensors, incorporation of sensors in the initial design, anticipated operational and failure conditions, resolution desired at various positions in a process or plant, reliability of the sensors, and the like.

In some embodiments, depending on the type of equipment, the component being measured, the environment in which the equipment is operating, and the like, sensors may include a vibration sensor, a thermometer, a hygrometer, a voltage sensor and/or a current sensor, an accelerometer, a velocity detector, a light or electromagnetic sensor, an image sensor, a structured light sensor, a laser-based image sensor, a thermal imager, an acoustic wave sensor, a displacement sensor, a turbidity meter, a viscosity meter, an axial load sensor, a radial load sensor, a tri-axial sensor, an accelerometer, a speedometer, a tachometer, a fluid pressure meter, an air flow meter, a horsepower meter, a flow rate meter, a fluid particle detector, an optical (laser) particle counter, an ultrasonic sensor, an acoustical sensor, a heat flux sensor, a galvanic sensor, a magnetometer, a pH sensor, and the like.

In some embodiments, a pressure testing system 10 may receive various data from a user, as shown in block 102 of FIG. 2. The input data from the user may include optimum operating values, operating procedure for the pressure testing, criteria for the pressure testing, etc.

In some embodiments, a pressure testing system 10 may receive various operating parameters such as pressure and temperature data from the sensors, as shown in Block 104 of FIG. 2, and performs advanced analytics on the pressure data over time. The pressure testing system 10 may use a set of algorithms to analyze the pressure data to determine if a Test passes or fails. The pressure testing system 10 may include a failing (red), inconclusive (yellow), or passing (green) indicator when it determines if a test has met or failed to meet criteria entered by the user, including the test pressure or required time duration of the test.

In some embodiments, a pressure testing system 10 may perform various analytics on the pressure data over time and generate a pressure testing assessment using the plurality of measured operating parameters and the plurality of user-supplied optimum operating values and a criteria associated with the pressure testing.

In some embodiments, a pressure testing system 10 may perform various analytics on the pressure data over time and generate a pressure testing assessment for each segment of the oil and gas facility. For example, a pressure testing assessment may include numbers from 1 to 10, with 1 representing that the requirements of a passing test have been satisfied thereby implying that no signs of failure or leakage have been detected and 10 representing that the requirements of a pasting test have not been satisfied thereby implying a sign of failure of a specific segment or possible leakage. Values in between 1 and 10 may represent how high the failure and leakage for a specific segment might be, with numbers closer to 1 representing lower chances of failure and numbers closer to 10 representing higher chances of failure.

In some embodiments, a pressure testing system 10 may perform a steady state material balance to check for potential failure and leakage in the oil and gas facility. Various levels of assumptions may be considered depending on the amount of data available for different segments of the oil and gas facility.

In some embodiments, a pressure testing system 10 may perform in real-time. Sensors may measure operating parameters in real-time and the pressure testing assessment may change in real-time based on the measure values, input values by the user, material balance calculations, etc.

In some embodiments, a pressure testing system 10 may include machine learning algorithms, trained on one or more data sets. The one or more data sets may include information collected using local data by the pressure testing system 10 or other data sets acquired from other oil and gas facilities. Learning may be human-supervised or fully-automated, such as using one or more input sources to provide a data set, along with information about the item to be learned about the pressure testing system 10, its goals, and underlying principles. Machine learning may use one or more models, rules, semantic understandings, workflows, or other structured or semi-structured understanding of a pressure testing system 10 in an oil and gas facility, such as for automated optimization of control of a system or process based on feedback or feed forward to an operating model for the system or process.

In some embodiments, a pressure testing system 10 may include machine learning algorithms to improve the foregoing, such as by adjusting one or more weights, structures, rules, or the like (such as changing a function within a model) based on feedback (such as regarding the success of a model in a given situation) or based on iteration (such as in a recursive process). Where sufficient understanding of the underlying structure or behavior of a system is not known, insufficient data is not available, or in other cases where preferred for various reasons, machine learning may also be undertaken in the absence of an underlying model; that is, input sources may be weighted, structured, or the like within a machine learning facility without regard to any a prior understanding of structure, and outcomes (such as those based on measures of success at accomplishing various desired objectives) can be serially fed to the machine learning system to allow it to learn how to achieve the targeted objectives regarding the pressure testing.

In some embodiments, a pressure testing system 10 may generate reports based on data files collected and analyzed. These reports may be used in producing an electronic record of the tests performed. The pressure testing system 10 may produce a PDF report detailing a summary of the testing, along with details that describe each test. The pressure testing system 10 may export raw data (e.g. time and pressure) and the pressure testing assessment in a separated file format and store them, as shown by block 108 of FIG. 2.

In some embodiments, a pressure testing system 10 may use a set of electrical components to capture raw pressure signals and convert into a digitized format readable by the computer system. This set of components maybe contained with an enclosure called a Field Test Unit (FTU)—a box containing electronics for digitizing signals produced by a pressure sensor. These signals may be part of a 4-20 mA current loop which are measured by the FTU. Internal components may convert the 4-20 mA into a 0-10 V signal which is then may be converted into a digital signal by a high-speed digitizer. The pressure testing system 10 may collect a waveform of samples of the voltage signal and then converts them into a pressure value based on the type of transducer or sensor connected.

In some embodiments, a pressure sensor may be placed at locations of measurement determined by the analyses being performed. The pressure sensors are installed in order to allow pressure analyses of multiple sub-systems (e.g., separate components) to be performed simultaneously or substantially simultaneously and in various locations. For example, pressure tests on various down hole tools could be performed simultaneously or substantially simultaneously (e.g., Gauge mandrels, Chemical injection mandrels, Surface controlled Subsurface Safety valves, control lines, rupture disc, etc.). This provides the ability to analyze, test, capture, verify, and document the function of these numerous tools while running them into the wellbore, and prior to terminating at the hanger.

In some embodiments, a pressure testing system 10 for testing during completions may have multiple transducers installed in the control cabin for the control lines going to each reel with the sensors connected to a FTU which is in the secured area of the cabin to avoid any potential hazards from chemicals, gas, etc. Each transducer may have its own criteria for the analysis set in the pressure testing system for the components being monitored (e.g., the data from each transducer may be fed into a dedicated analyst).

In some embodiments, a pressure testing system for analysis and testing during Shear Testing may have multiple transducers installed on the open side, one on the closed side, and on the wellbore. This may enable the capture of a comparatively precise shear pressure by monitoring the close pressure, as well as, the open pressure substantially simultaneously because of the high-speed sampling rate at which the pressure testing system may acquire pressure values. In some embodiments, a net shear value may be obtained by recording and plotting the entire shear process.

In some embodiments, a pressure testing system may be setup by a user entering information—including information about the pressure transducer's rating and scale (e.g., 20,000 psi)—about each part of the fluidic process that is being monitored.

In some embodiments, a pressure testing system may be setup in two modes: single analysis or multiple concurrent analyses. The pressure testing system may read data from the FTU processing the digital waveform of voltage and convert it into pressure values. The pressure values are then sent for analysis.

In some embodiments, the pressure testing system 10 may be flexible with regards to the physical computers used for data collection and data analysis. Different computers may be used for viewing of the analyses in different areas in a facility. For example, the pressure testing system 10 may be started on computer A. Computer A is connected to the FTU. The pressure testing system 10 starts collecting data on computer A and initiates analyzing the data on a separate computer, computer B.

In some embodiments, the pressure testing system 10 may perform multiple tests simultaneously.

In some embodiments, concurrent and sequential digital pressure analysis of pressure control equipment may be achieved by a multi-test system, called ‘Big Bertha,’ which enables conducting two, three or four independent analyses simultaneously.

In some embodiments, a multi-test system, called ‘Big Bertha,’ may be used during completion stage testing when control lines and downhole tools may be being tested concurrently.

In some embodiments, a set of non-transitory computer readable media are disclosed that have been developed for concurrent and sequential digital pressure analysis of pressure control equipment within the oil & gas industry, and certain other pressure systems to which the principles described herein can equally apply.

In some embodiments, the types of analysis envisioned include testing, diagnostic analysis, and monitoring of pressure and flow control systems during drilling, completions, work-overs, and intervention of wells, including systems related to the well itself (e.g., in the annulus), wellhead, trees, manifolds, jumpers, flow lines, topside components, tools, and pipelines.

In some embodiments, a pressure testing system may conduct two, three or four independent analyses simultaneously. In some embodiments, a pressure testing system may perform more than four independent analyses simultaneously.

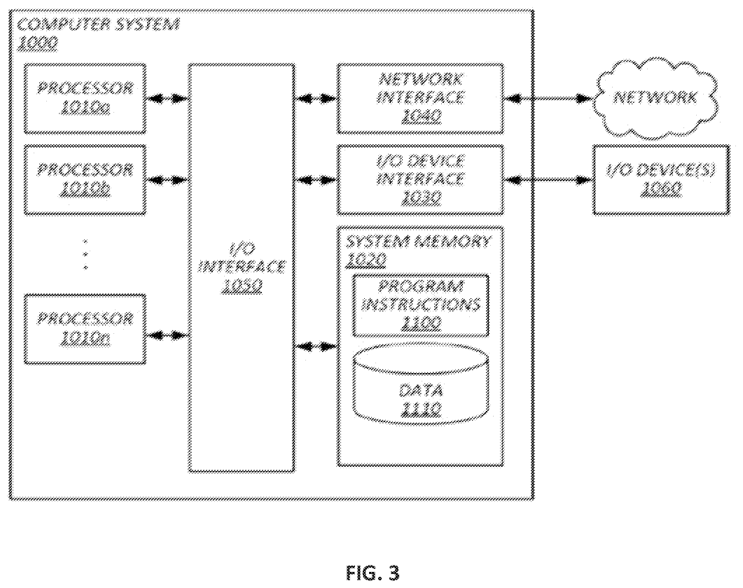

FIG. 3 is a diagram that illustrates an exemplary computing system 1000 by which embodiments of the present technique may be implemented. Various portions of systems and methods described herein, may include or be executed on one or more computer systems similar to computing system 1000. Further, processes and modules described herein may be executed by one or more processing systems similar to that of computing system 1000.

Computing system 1000 may include one or more processors (e.g., processors 1010a-1010n) coupled to system memory 1020, an input/output I/O device interface 1030, and a network interface 1040 via an input/output (I/0) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g, system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g, from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface may 1040 may facilitate data exchange between computer system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium that may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 1050 may be configured to coordinate I/O traffic between processors 1010a-1010n, system memory 1020, network interface 1040, I/O devices 1060, and/or other peripheral devices. I/O interface 1050 may perform protocol, timing, or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000 or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, not withstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may provided by sending instructions to retrieve that information from a content delivery network.

The reader should appreciate that the present application describes several independently useful techniques. Rather than separating those techniques into multiple isolated patent applications, applicants have groupedthese techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the figures are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. The term “or” is, unless indicated otherwise, non-exclusive, i.e., encompassingboth “and” and “or.” Terms describing conditional relationships, e.g, “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Further, unless otherwise indicated, statements that one value or action is “based on” another condition or value encompass both instances in which the condition or value is the sole factor and instances in which the condition or value is one factor among a plurality of factors. Unless otherwise indicated, statements that“each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square”, “cylindrical,” and the like, should be construed as encompassing items that substantially embody the properties of the geometric construct, e.g., reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms “first”, “second”, “third,” “given” and so on, if used in the claims, are used to distinguish or otherwise identify, and not to show a sequential or numerical limitation.

In this patent, certain U.S. patents, U.S. patent applications, or other materials (e.g., articles) have been incorporated by reference. The text of such U.S. patents, U.S. patent applications, and other materials is, however, only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

The present techniques will be better understood with reference to the following enumerated embodiments:
1. A tangible, non-transitory, machine-readable medium storing instructions that when executed by one or more processors effectuate operations including: obtaining, with one or more processors, a plurality of user-supplied optimum operating values corresponding to a plurality of operating parameters in an oil and gas facility; obtaining, with one or more processors, a plurality of measured operating parameters, wherein: each of the measured operating parameters of the plurality of measured operating parameters is obtained concurrently from a detection package, the detection package comprising: at least one of a plurality of input sensors, wherein: each of the plurality of input sensors is operatively

What is claimed is:

1. A tangible, non-transitory, machine-readable medium storing instructions that when executed by one or more processors effectuate operations comprising:
obtaining, with one or more processors, a plurality of user-supplied optimum operating values corresponding to a plurality of operating parameters in an oil and gas facility;
obtaining, with one or more processors, a plurality of measured operating parameters, wherein:
each of the measured operating parameters of the plurality of measured operating parameters is obtained concurrently from a detection package, the detection package comprising:
at least one of a plurality of input sensors, wherein:
each of the plurality of input sensors is operatively coupled to at least one of the operating parameters in the oil and gas facility;
each of the plurality of input sensors has a radio frequency identification;
at least some of the plurality of input sensors are pressure sensors; and
at least some of the plurality of input sensors are temperature sensors;
generating, with one or more processors, a pressure testing assessment using the plurality of measured operating parameters, the plurality of user-supplied optimum operating values and a criteria associated with the pressure testing; and
storing, with one or more processors, the pressure testing assessment for subsequent output and monitoring of the oil and gas facility.

2. The medium of claim 1 further comprising:
data-encoding means operatively associated with the oil and gas facility for generating digital data representing the value of each of the plurality of input sensors and for arranging the position of the digital data in a sequence of a multiplicity of bits so that each bit bears a known relationship of a parameter from the plurality of measured operating parameters.

3. The medium of claim 1 further comprising:
modulating means operatively associated with the detection package and configured to provide electrical signals representative of the plurality of measured operating parameters.

4. The medium of claim 1, wherein the pressure testing assessment comprises a steady state material balance analysis based on the plurality of measured operating parameters.

5. The medium of claim 1 further comprising:
forming a set of instructions, wherein the instructions are suggested to be executed by a user in case of a leakage in the oil and gas facility.

6. The medium of claim 1 further comprising:
means at above sea level for monitoring the plurality of measured operating parameters to determine in combination with the pressure testing assessment for providing a simultaneous indication of pressure level and temperature of the oil and gas facility.

7. The medium of claim 1, wherein the plurality of input sensors provide data in real-time and the pressure testing assessment is calculated in real-time.

8. The medium of claim 1 further comprising:
dynamically updating at least one user-supplied optimum operating value based upon user input.

9. The medium of claim 1 further comprising:
means for generating and outputting a graphical user interface to a user, wherein the graphical user interface present the plurality of measured operating parameters and the pressure testing assessment in real-time.

10. The medium of claim 1, the operations comprising:
steps for determining leakage in an oil and gas facility.

11. A method, comprising:
obtaining, with one or more processors, a plurality of user-supplied optimum operating values corresponding to a plurality of operating parameters in a oil and gas facility;
obtaining, with one or more processors, a plurality of measured operating parameters, wherein:
each of the measured operating parameters of the plurality of measured operating parameters is obtained concurrently from a detection package, the detection package comprising:
at least one of a plurality of input sensors, wherein:
each of the plurality of input sensors is operatively coupled to at least one of the operating parameters in the oil and gas facility;
each of the plurality of input sensors has a radio frequency identification;
at least some of the plurality of input sensors are pressure sensors; and
at least some of the plurality of input sensors are temperature sensors;
generating, with one or more processors, a pressure testing assessment using the plurality of measured operating parameters, the plurality of user-supplied optimum operating values, and a criteria associated with the pressure testing; and
storing, with one or more processors, the pressure testing assessment for subsequent output and monitoring of the oil and gas facility.

12. The method of claim 11 further comprising:
data-encoding means operatively associated with the oil and gas facility for generating digital data representing the value of each of the plurality of input sensors and for arranging the position of the digital data in a sequence of a multiplicity of bits so that each bit bears a known relationship of a parameter from the plurality of measured operating parameters.

13. The method of claim 11 further comprising:
modulating means operatively associated with the detection package and configured to provide electrical signals representative of the plurality of measured operating parameters.

14. The method of claim 11, wherein the pressure testing assessment comprises a steady state material balance analysis based on the plurality of measured operating parameters.

15. The method of claim 11 further comprising:
forming a set of instructions, wherein the instructions are suggested to be executed by a user in case of a leakage in the oil and gas facility.

16. The method of claim 11 further comprising:
means at above sea level for monitoring the plurality of measured operating parameters to determine in combination with the pressure testing assessment for providing a simultaneous indication of pressure level and temperature of the oil and gas facility.

17. The method of claim 11, wherein the plurality of input sensors provide data in real-time and the pressure testing assessment is calculated in real-time.

18. The method of claim 11 further comprising:
dynamically updating at least one user-supplied optimum operating value based upon user input.

19. The method of claim 11 further comprising:
means for generating and outputting a graphical user interface to a user, wherein the graphical user interface present the plurality of measured operating parameters and the pressure testing assessment in real-time.

20. The method of claim 11, the operations comprising:
steps for determining leakage in an oil and gas facility.
